(19) United States
(12) Patent Application Publication
(10) Pub. No.: US 2006/0221354 A1
(43) Pub. Date: Oct. 5, 2006

(54) Automatic printing device selection based on human-readable form submission

(76) Inventors: Charles Slaten, Georgetown, TX (US); Marc Gomillion, Austin, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/097,642

(22) Filed: Apr. 1, 2005

(51) Int. Cl. G06F 3/12

(52) U.S. Cl. 358/1.1; 358/1.15

(57) ABSTRACT

A method for the automatic selection of a printing device among a network of printing devices includes capturing a human-readable job ticket that conveys the specifications of a print job. The method continues with converting the human-readable job ticket into a set of computer-readable instructions and selecting the specific printing device from the network of printing devices based on the set of computer-readable instructions. The specific printing device is then identified to the user.

### BACKGROUND OF THE INVENTION

In many workplaces or other enterprises where printing is performed, a “job ticket” is used to define the attributes of finished printed material. For example, when a customer enters a commercial print shop, he or she may fill out a job ticket that indicates how many copies are needed, whether or not the copies are to be one-sided or two-sided, and so forth. After a few minutes, the print shop employee presents the completed printed material to the customer, who then verifies the characteristics of the printed material and leaves.

As printers and copiers begin to merge into more capable “All-In-One” devices, the user interface often consists of numerous selections that present the user with a myriad of printing options. In many instances, entering selections by way of the small display is not a pleasing experience, requiring the user to squint in order to read the characters presented on the display. Further, if the user interface includes a touch screen, small errors in the placement of the user's finger on the touch screen can cause the user to make erroneous selections. This can cause the user to waste time and printing supplies while he or she adjusts the selections on the display.

### BRIEF DESCRIPTION OF THE DRAWINGS

FIG. 1 is a block diagram of a system for automatic printing device selection based on human-readable form submission according to an embodiment of the invention.

FIG. 2 is a method for automatic printing device selection based on human-readable form submission according to an embodiment of the invention.

### DESCRIPTION OF THE EMBODIMENTS

In the embodiments of the invention disclosed herein, a method and system for automatic printing device selection based on human-readable form submission allows a user to select various printed output attributes using a human-readable job ticket. In one embodiment of the invention, the user prints a blank job ticket and then enters the desired attributes of the completed printed material onto the blank job ticket. The completed human-readable job ticket is then input into an optical scanning device that scans the job ticket while the ticket is in contact with the platen of the scanning device. The scanning device then captures the information present on the human-readable job ticket and converts the information to a set of computer-readable instructions. Based on the set of computer-readable instructions, logic either within the scanning device or external to the device (such as in a selection processor) selects an appropriate printing device available to the user to complete the job according to the user's intent as indicated on the job ticket. The user is then notified of the specific printing device capable of preparing the printed output. In one embodiment of the invention, the print job is also automatically conveyed to the specific printing device, which then completes the prints the material as specified on the completed job ticket.

In the context of the present invention, a broad definition of the term “printing device” is contemplated. Thus, a printing device may be a stand-alone printer attached to one or more desktop or laptop computers by way of a dedicated connection or by way of a wireless or wired network interface. A printing device may also be a networked printer that also functions as a copier. In addition to printing and copying functions, the printing device may also be capable of scanning documents so that an electronic representation of the document can be generated and conveyed to a user.

In at least one embodiment of the invention, the user is provided with the location information of the selected printing device so that the user can directly interface with the device. When the selected printing device includes a scanner, an embodiment of the invention may include the user being presented with a paper-based computer-readable job ticket summary that allows the user to configure the selected printing device by merely inputting the job ticket summary into the scanner of the selected printing device.

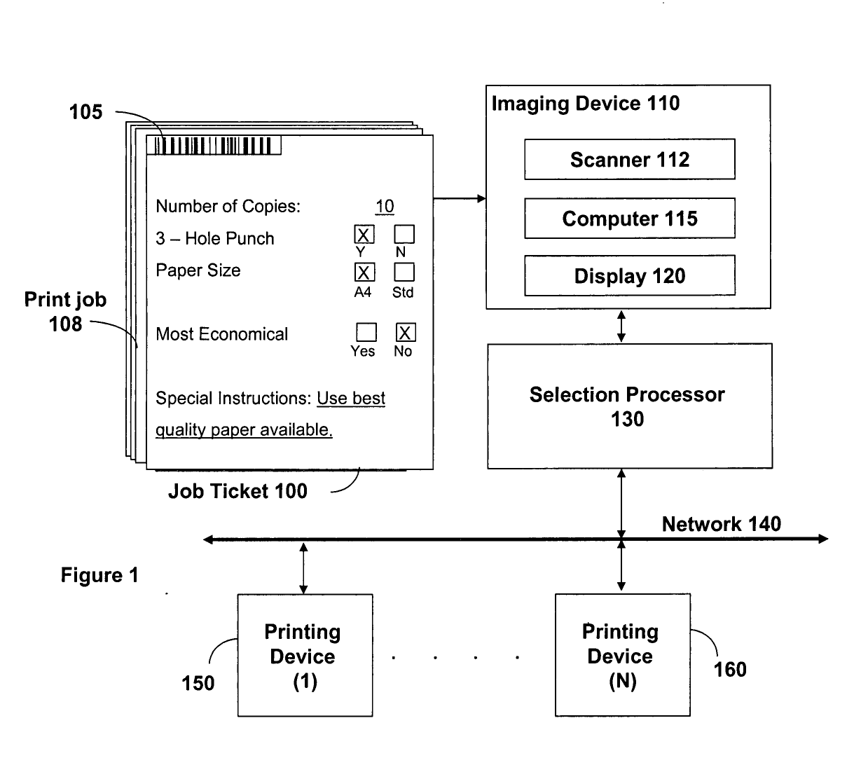

FIG. 1 is a block diagram of a system for automatic printing device selection based on human-readable form submission according to an embodiment of the invention. In FIG. 1, job ticket 100 identifies the user's intent for a given print job (108). Thus, as shown in FIG. 1, the intent may include the number of copies, whether the completed job is to be printed using three-hole-punched paper, whether the paper is to be A4 or a standard-sized paper (such as 8.5×11 inches or 21.6×28 cm), and so forth. Job ticket 100 may include numerous other selections which allow the user to control the manner in which printing is performed, the paper or other substrate on which the print job is printed, as well as any post-print processing operations such as cutting and binding.

Job ticket 100 is then input into imaging device 110, which may be a combined printer and scanner, or may only include the capability to scan documents and convert the documents into a set of computer-readable instructions. Thus, depending on the capabilities of imaging device 110, job ticket 100 may either represent a cover page submitted along with print job 108, or may be input into imaging device 110 as a stand-alone document that is used to select a printing device that can perform printing functions as specified on job ticket 100.

In the event that imaging device 110 is a combined printer and scanner that includes an input paper bin capable of printing or scanning many documents per minute, job ticket 100 may be used as a cover page that precedes print job 108. In the event that imaging device 110 possesses a much smaller document throughput capacity, perhaps being capable of scanning or printing less than ten documents per minute, job ticket 100 may be input as a stand-alone document. In either case, imaging device 110 includes the image processing and computational resources necessary to convert the human-readable job ticket into a set of computer-readable instructions. Imaging device 110 may also include a processor that prepares an XML document in accordance with and XSL style sheet that expresses the computer-readable instructions. Through the use of an XML document, the computer-readable instructions can be conveyed using a standardized language.

As shown in FIG. 1, job ticket 100 includes barcode 105, which allows scanner 112 and computer 115 of the imaging device to identify the document as a job ticket as opposed to a print job. In other embodiments, job ticket 100 makes use of other identifying indicia, such as a watermark, a two dimensional bar code, or even a certain icon or shape, to identify to computer 115 of imaging device 110 that a job ticket is present. In still other embodiments of the invention, computer 115 may identify job ticket 100 by way of one or more colored inks or perhaps by the particular color of paper on which the job ticket is printed. Thus, in one embodiment of the invention, paper or ink of a certain shade of blue may be used to identify job ticket 100 to computer 115 of the imaging device. However, regardless of the manner in which job ticket 100 is identified, the identification allows imaging device 110 to discriminate human-readable job ticket 100 from print job 108.

Returning to the embodiment of FIG. 1, a broad range of human-readable document arrangements is contemplated. Thus, the job ticket 100 may include an area where a user enters an Arabic numeral, such as the number 10shown in the “number of copies” field. Job ticket 100 may also include an area where a user enters a check mark, an “X” in a box, or other mark in an appropriate area, such as adjacent to the “3-hole punch” field. In other embodiments, a more free-form approach utilizing handwriting recognition may be used in order to convey the user's intent to imaging device 110.

After the human-readable entries on job ticket 100 are converted into computer-readable instructions, these instructions are conveyed to selection processor 130. In the embodiment of FIG. 1, selection processor 130 maintains a database that includes the capabilities of each of printing devices 1 through N interfaced to network 140, as well as information as to the On/Off status of printing devices 150 and 160. For example, selection processor 130 may be aware of whether or not printing devices 150 and 160 currently possess three-hole punched paper in the respective printing device's paper bin, whether the printing device can perform post-print processes such as cutting and binding, and whether A4-sized paper has been loaded, and so forth. In addition to these, selection processor 130 may possess information as to the cost per page of any specific printing device interfaced to network 140, as well as how that cost per page compares with the remainder of printing devices 1 through N. Thus, selection processor 130 is capable of selecting the specific printing device interfaced to network 140 which can perform the printing functions according to the user's intent as specified on job ticket 100.

In the embodiment of FIG. 1, selection processor 130 automatically transmits an electronic representation of print job 108 to the specific printing device interfaced to network 140. Selection processor 130 then conveys information regarding the selected printing device to display 120 present on imaging device 110. The user can then be notified as to which of printing devices 1 through N is currently printing the users print job. In addition to this notification, selection processor 130 may generate a configuration file, perhaps using Extensible Markup Language (XML) formatted using an XSL style sheet, in order to convey the printer settings to the selected printing device. In this embodiment, selection processor 130 as well as printing devices 1 through N make use of an XML schema that define the set of attributes that can be used to express the user's intent. The XML-expressed attributes are then used to control the settings of the selected destination printing device. XML files formatted using and XSL style sheet may also be used to command printing devices 150 and 160 to generate a blank human-readable job ticket. In the event that imaging device 110 is capable of printing, an XML file may be used to command this device to generate the blank human-readable job ticket.

It is contemplated that at least two types of scannable, human-readable job ticket forms may used. One form may be used simply to allow a user to locate a particular type of printing device, such as one that can perform post print cutting or binding. In this embodiment, no print job accompanies the input of this scannable form, and the user is directed to the physical location of the selected printing device. The user can then interface with the selected printing device directly, perhaps configuring the device by way of inserting the completed job ticket into the printing device. In another embodiment, a second form may be used as a cover sheet to print job 108 that enables the selection processor to locate a printing device as well as submit the print job to the selected device for completion. The user may then approach the selected printing device and retrieve his or her printed output.

As shown on job ticket 100, embodiments of the invention may allow the user to specify the user's desire for “most economical” printing. This may be advantageous in commercial print shop environments where a highly cost-conscious user may desire the least expensive printing possible. In this case, selection processor 130 may select from a variety of printing devices interfaced to network 140 and select the printing device which provides high-quality printing at the lowest possible price.

In FIG. 1, network 140 has been shown as a single line that includes a direct connection between selection processor 130 and printing devices 150 and 160. However, network 140 may include other network components, such as network hubs and routers, as well as many other devices such as servers, personal computers, and other network or computing elements. Further, network 140 may represent a wired or wireless network within a particular business, or may represent the public Internet having wireless and wired network components.

In another embodiment of the invention, selection processor 130 may not exist as a stand-alone unit, but rather may be included in imaging device 110. In this embodiment, the selection processor function and the interface to network 140 are provided by imaging device 110.

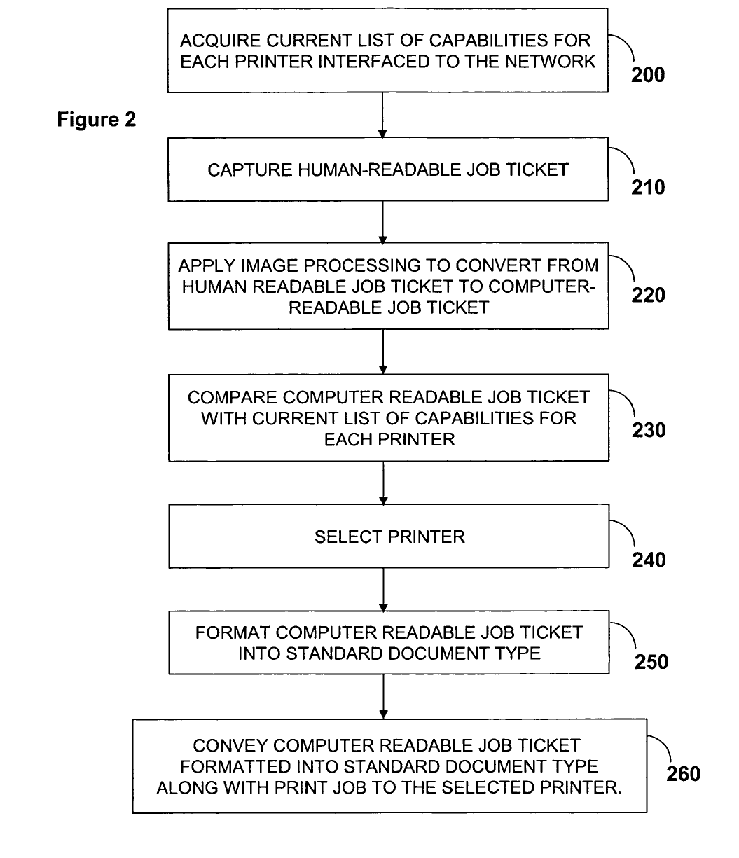

FIG. 2 is a method for automatic printing device selection based on human-readable form submission according to an embodiment of the invention. The system of FIG. 1 is suitable for performing the method of FIG. 2, although the method may be performed by a variety of other equipment configurations. The method of FIG. 2 begins at step 200, wherein a selection processor (such as selection processor 130) acquires a current list of capabilities of each printing device interfaced to a network. If the selection processor is already in possession of the list, step 200 may instead consist of updating the list so as to ensure that a current list is maintained.

At step 210, an imaging device (such as imaging device 110) captures a human-readable job ticket. In the embodiment of FIG. 2, the job ticket codifies the user's intent of the print job. Thus, the job ticket may include the number of copies desired, the paper or other substrate on which the output should be printed, and so forth. The method continues at step 220, in which an image processing algorithm is applied to the human-readable job ticket to convert the human-readable job ticket to a set of computer-readable instructions. Step 220 may include the imaging device recognizing identifying indicia present on the job ticket.

At step 230, the set of computer-readable instructions is compared with the current list of capabilities of each printing device interfaced to the network. At step 240, a printing device having capabilities that either precisely or closely match the intent identified on the human-readable job ticket is selected. The selected printing device is then identified to the user, such as by way of display 120 of FIG. 1. The selection step of page 240 may also include comparing cost per page information in the event that the user has requested “most economical”printing.

At step 250, the computer-readable job ticket is formatted into a standardized document, such as an XML document prepared according to a chosen schema. At step 260, the XML document is conveyed to the selected printing device. Thus, when the user approaches selected printing device, the printing device may already be configured to accommodate the incoming print job. The user may the insert the print job into the printing device's tray and print the job without further interaction. Alternatively, the print job can be conveyed to the printing device along with the XML document. In this embodiment, the print job can be scheduled and be in-process by the time the user approaches the selected printing device.

In other embodiments of the invention, a reduced number of the steps of FIG. 2 may be performed. Thus, a method for the automatic selection of a printing device among a network of printing devices may only include capturing a human-readable job ticket that conveys the specifications of a print job (step 210), converting the human-readable job ticket into a set of computer-readable instruction (step 220), selecting the specific printing device from the network of printing devices based on the set of computer-readable instructions (step 240), identifying the specific printing device to the user (step 260).

In conclusion, while the present invention has been particularly shown and described with reference to various embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method for the automatic selection of a printing device among a network of printing devices, comprising:
capturing a human-readable job ticket that conveys the specifications of a print job;
converting the human-readable job ticket into a set of computer-readable instructions;
selecting the specific printing device from the network of printing devices based on the set of computer-readable instructions; and
identifying the specific printing device to the user.

2. The method of claim 1, additionally comprising printing the print job using the specific printing device, the printing step being performed after the identifying step.

3. The method of claim 1, wherein the human-readable job ticket includes user-selected attributes entered on the job ticket.

4. The method of claim 3, wherein at least a portion of the human-readable job ticket is written in the user's own handwriting.

5. The method of claim 1, additionally comprising an imaging device discriminating the human-readable job ticket from an attached print job.

6. The method of claim 5, wherein the discriminating step includes the imaging device reading a bar code positioned on the human-readable job ticket.

7. The method of claim 5, wherein the discriminating step includes the 30 imaging device reading one of an icon or a shape positioned on the human-readable job ticket.

8. The method of claim 5 wherein the discriminating step includes the imaging device determining that one of a certain colored paper or a certain colored ink is present.

9. The method of claim 1, wherein the computer-readable instructions are formatted into an XML file.

10. The method of claim 1, wherein the capturing step includes optically scanning the human-readable job ticket.

11. The method of claim 1, additionally comprising printing a blank human-readable job ticket.

12. A system for automatic printing device selection and print job routing, comprising:
an imaging device for converting a human-readable job ticket into computer-readable instructions;
a selection processor for determining that one of a plurality of printing devices interfaced to a network is capable of producing printed output in conformance with the user's intent as specified on the human-readable job ticket; and
a display for identifying to the user that the specific printing device has been selected by the selection processor.

13. The system of claim 12, wherein the imaging device converts marks placed in selected areas of the human-readable job ticket into computer-readable instructions.

14. The system of claim 12, wherein the imaging device converts a user's handwriting into computer-readable instructions.

15. The system of claim 12, wherein the imaging device identifies a human-readable job ticket by way of identifying indicia located on the job ticket.

16. The system of claim 15, wherein the identifying indicia is a bar code located on the job ticket.

17. The system of claim 12, wherein computer-readable instructions correspond to an XML file communicated between the imaging device and the selection processor.

18. A system for automatically selecting a printing device, comprising:
means for receiving a human-readable job ticket, the human-readable job ticket specifying the desired attributes of printed output;
means for converting the human-readable job ticket into computer-readable instructions;
means for determining that at least one printing device of a plurality of printing devices interfaced to a network can provide the printed output; and
means for identifying the at least one printing device to a user.

19. The system of claim 18, wherein the means for receiving a human-readable job ticket includes an optical scanner wherein the job ticket is scanned while in contact with a platen.

20. The system of claim 18, wherein the means for converting the human-readable job ticket to computer-readable instructions includes a bar code reader that reads a bar code located on the human-readable job ticket.

21. The system of claim 18, wherein the means for identifying to the user includes a display portion of the means for receiving the human-readable job ticket.

22. The system of claim 18, further comprising means for producing a blank human-readable job ticket.

23. The system of claim 22, wherein the means for producing a blank human-readable job ticket includes means for receiving and XML document and an XSL style sheet.
